(19) United States
(12) Patent Application Publication
(10) Pub. No.: US 2022/0160481 A1
(43) Pub. Date: May 26, 2022

(54) Instrument Support for a Treatment Device and Treatment Device Comprising Said Instrument Support

(71) Applicant: FERTON HOLDING S.A., DELÉMONT (CH)

(72) Inventors: Andreas MENNE, Tägerwilen (CH); M. Rolf MEISNER, Gilly (CH)

(21) Appl. No.: 17/430,810

(22) PCT Filed: Mar. 2, 2020
(86) PCT No.: PCT/EP2020/055459

§ 371 Date: Aug. 13, 2021

(30) Foreign Application Priority Data
Mar. 1, 2019 (DE) 10 2019 105 312.9

(51) Int. Cl. A61C 17/00; A61C 3/025; A61G 15/16

(52) U.S. Cl. CPC A61C 17/005; A61G 15/16; A61C 3/025

(57) ABSTRACT

Instrument carrier of a treatment device, in particular a dental treatment device, wherein a primary instrument is provided on the treatment device and wherein at least a part of the at least one primary instrument is an integral component of the treatment device, where the instrument carrier has an interface on the instrument carrier side for connecting, preferably reversibly connecting, a modular secondary instrument, where the secondary instrument is preferably a powder jet device.

### TECHNICAL FIELD

The present disclosure relates to an instrument carrier for a treatment device, in particular a dental treatment device, and to a treatment device having such an instrument carrier.

### BACKGROUND

Such treatment devices are known, for example, from DE 10 2013 224 764 B1, EP 2 101 680 A1 or EP1 817 705 B1. This is typically a central workstation and location where the patient is positioned for treatment in the dental practice. This treatment device is typically designed to provide the full range of dental services. Almost all of the primary instruments and/or functionalities required for this are integrated in this treatment unit or at least are connected to it. These are, for example, adjustable positioning for the patient, lighting, camera system, rinsing basin, various turbine and motor connections, rinsing and/or suction devices. The patient generally remains on the support during treatment and is cared for or treated with the aid of the primary instruments arranged around him.

In recent years, dental prophylaxis has become increasingly important as an independent service. The patient is examined in advance by a dentist and the general dental status is recorded. This is followed by cleaning of the teeth and further prophylactic measures to maintain oral health. This is usually no longer done by the dentist himself, but by a specially trained specialist, a dental hygienist.

Dental treatment devices usually do not have a powder jet function, because the handling of the powder within the treatment device is technically complex and leads to handling disadvantages. Such powder jet units are usually located on a separate equipment trolley next to the treatment unit or are placed on the storage area for dental instruments. Both are associated with disadvantages. The equipment trolley requires additional space, must be supplied with electricity, water and compressed air, and the storage area is usually required for storing the dental instruments. It is therefore advantageous to provide a treatment unit which does not have these disadvantages.

### BRIEF SUMMARY

Based on the prior art, the present disclosure therefore seeks to improve the treatment devices known from the prior art, in particular with regard to their use for prophylaxis.

According to a first aspect of the present disclosure, an instrument carrier of a treatment device, in particular a dental treatment device, is provided, wherein a primary instrument is provided on the treatment device, wherein at least part of the at least one primary instrument is an integral component of the treatment device, characterized in that the instrument carrier has an interface on the instrument carrier side for connecting, preferably reversibly connecting, a modular secondary instrument, wherein the secondary instrument is preferably a powder jet device.

Compared to treatment devices known from the prior art, it is provided according to the disclosure that the instrument carrier has an interface for connecting the modular secondary instrument so that the modular secondary instrument can use, for example, at least one supply line, in particular a first and/or second supply line, which is provided by the treatment device, in particular the instrument carrier. In this context, it proves to be particularly advantageous that the secondary instrument is modular, i.e., with the exception of the first and/or the second supply line, substantially all functional elements for the prophylaxis treatment, such as a mixing chamber, are arranged outside the instrument carrier, so that simple maintenance and/or cleaning of the secondary instrument is possible. This is particularly advantageous if the secondary instrument is a powder jet instrument for which easy access to the powder containers and/or the mixing chamber is necessary to enable refilling or cleaning. Accordingly, integration of the powder jet function in the treatment unit or in the instrument carrier can thus be advantageously avoided. This is particularly advantageous because, in the event of a leak or defect in the powder jet line, considerable damage could occur in the treatment device. Instead, in the case of instrument carriers according to the disclosure, any leaking operating media can simply be removed, e.g. wiped, from the secondary instrument and/or the instrument carrier.

Instead of integration into the treatment device, it is therefore intended to arrange the modular secondary instrument on the outside of the instrument carrier by means of the interface. For example, the secondary instrument is arranged on the instrument carrier. It is also possible that the modular secondary instrument is hooked or arranged on the side of the instrument carrier in the assembled state. A further advantage of forming an interface on the instrument carrier is that an additional supply device or supply line or control device for the secondary instrument, i.e. formed outside the treatment device or the instrument carrier, can be dispensed with, and instead can be integrated into the treatment device or into control devices of the treatment device. It is also conceivable that the modular secondary instrument is permanently connected to the instrument carrier of the treatment device.

Furthermore, it is provided that the primary instrument is essentially provided as a hand-held device, while the secondary instrument also has its own hand-held device in addition to a hand-held device, which is provided in particular for emitting a powder-gas mixture. Preferably, the hand-held device of the secondary instrument is arranged next to the primary instruments, in particular next to the primary instruments provided as hand-held devices. For example, the primary instruments and the hand-held device of the secondary instrument are suspended from or attached to a common ledge or side section of the instrument carrier, preferably in corresponding recesses or notches, so that the user can quickly switch between the primary instruments and the hand-held device of the secondary instrument.

Furthermore, it is conceivable that a valve, preferably a proportional valve and more preferably a pinch valve, is provided for adjusting an amount of a powder-gas mixture to be ejected from the powder jet instrument, the valve being arranged outside the instrument carrier. Preferably, the valve is a pinch valve which comprises a hose, the cross-section of which is adapted to the current demand of the powder-gas mixture to be ejected. Furthermore, it is provided that the valve is arranged downstream, seen in the direction of flow, of an area in which the powder and the gas are mixed to form a powder-gas mixture. In this case, the valve can be arranged in the secondary instrument, preferably in the area of an output channel or at an output of the secondary instrument, which in turn is connected to the instrument carrier via a hose, and/or in an output channel or in an output of the instrument carrier, which supplies the hand-held device of the secondary instrument with the powder-gas mixture.

Furthermore, a connecting line is provided, which connects the secondary instrument to the instrument carrier and via which a powder-gas mixture is conveyed or conducted from the secondary instrument to the instrument carrier, wherein the instrument carrier in turn preferably supplies a hand-held device, which is associated with the secondary instrument, but which is particularly preferably—permanently or detachably—connected to or formed on the instrument carrier, with the powder-gas mixture. The hand-held device associated with the secondary instrument then ejects the powder-gas mixture during use.

Particularly preferably, the valve is integrated in a connection element via which, for example, the hand-held device associated with the secondary instrument can be connected to the instrument carrier, in particular in a detachable manner, or via which the connection line is connected or can be connected to the secondary instrument or to the instrument carrier. This significantly simplifies access to the valve. This proves to be particularly advantageous because these valves are high-maintenance and, in the event of a defect, lead to a great deal of contamination from powder flying around. In a corresponding manner, this design allows easy access to the valve, in particular without opening the instrument carrier or even the secondary instrument.

Furthermore, it is conceivable that the secondary instrument is placed or arranged at a fixed area on the instrument carrier and is not arranged to be movable relative to the instrument carrier during operation (with the exception of a hand-held device associated with the secondary instrument). For example, the secondary instrument has a base body that is larger than the extent of the primary instrument and is preferably arranged on the instrument carrier.

Preferably, the treatment device is designed for dental prophylaxis, in particular it is used exclusively for dental prophylaxis. Accordingly, for such a treatment device, apart from a chair, lighting, a sink, a suction device, a hand-held device for emitting compressed air and/or water and a device for scaling by means of ultrasound (a so-called “scaler”), no further primary instrument is provided. Other examples of primary instruments could be, for example, drilling instruments and/or grinding instruments (e.g., an angle piece for polishing) in other treatment devices.

The primary instrument differs from the modular secondary instrument in particular in that it is an integral part or mostly integral part of the treatment device. For example, only head elements or attachments, such as a contra-angle handpiece, can be replaced on the primary instruments, which, for example, have no function-triggering effect, such as a motor for driving or preparing media for treatment. For example, motors and/or drives are included in corresponding hand-held devices of the primary instrument that are a fixed or integral part of the treatment device, or are integrated into the treatment device. In contrast, in the modular secondary instrument, the preparation of the medium, for example the mixing of a powder with a gas to form a powder-gas mixture, is provided within the modular secondary instrument, and thus does not take place in the instrument carrier or the treatment device.

Preferably, the secondary instrument is a powder jet device which has, for example, a mixing chamber and/or a hand-held device or handpiece and is intended to emit a powder-gas mixture via a blasting nozzle, which is surrounded in particular by a liquid jacket. Such powder jet devices are used for the gentle removal of impurities or biofilms which form on teeth.

According to a preferred embodiment, it is provided that the instrument carrier, in particular the interface on the instrument carrier side, for connecting the secondary instrument comprises
a mechanical fixation mechanism and/or
at least one first connection for connecting, in particular reversibly connecting, a first supply line to a first coupling component of the secondary instrument and/or a second connection for connecting, in particular reversibly connecting, a second supply line to a second coupling component of the secondary instrument and/or
an electrical connection for the power supply and/or for information exchange.

In particular, it is intended that the secondary instrument, i.e. the modular secondary instrument, can be positioned fixed in position on the instrument carrier by means of the mechanical fixation mechanism. For this purpose, the instrument carrier interacts, for example in the interface area, in a form-locking and/or force-locking manner with the powder jet device or the secondary instrument, e.g. with its housing. It is conceivable, for example, that a latching mechanism, clip mechanism, magnetic fixation and/or a hook-and-loop fastening system is provided, with which a mechanical connection or fixation between the secondary instrument and the instrument carrier is possible.

Furthermore, it is provided that a connection of the secondary instrument with the first supply line and/or the second supply line is possible via the first connection and/or the second connection, whereby operating means required for operation can be made available to the secondary instrument. In particular, according to one embodiment of the disclosure, it is provided that water is provided via the first supply line, in particular water with a pressure between 0 and 5 bar, in particular between 1 and 4 bar, and/or a compressed air is provided via the second connection line, in particular a compressed air with a pressure between 2 and 8 bar. Furthermore, according to one embodiment of the disclosure, it is provided that, in the assembled state, a connection of a third supply line with a third coupling component of the powder jet equipment can be realized via a third connection. Via the third supply line, powder can be provided to the powder jet device at the third connection, for example, or a powder/air mixture can be discharged and supplied to a handpiece on the treatment device side. Preferably, it is provided that the first supply line, the second supply line and/or the third supply line run within the treatment equipment, in particular within the instrument carrier, and are connected, for example, to a central body of the treatment device.

It is also envisaged that the interface on the instrument carrier side has an electrical connection which permits a power supply to the powder jet device. Alternatively or additionally, it is conceivable that an information exchange, in particular a bidirectional data exchange, is possible between the secondary instrument and the instrument carrier or the treatment device via an electrical connection. As a result, it is not only possible to output control signals to the powder jet device, but it is also possible to obtain information about the powder jet device. This makes it possible, for example, to detect malfunctions or an absence or presence of a particular secondary instrument. In addition, appropriate cleaning and maintenance information, for example concerning the times or the measures of cleaning and maintenance, can be provided via the electrical connection. Furthermore, it is conceivable that a coupling of the secondary instrument to the instrument carrier takes place automatically.

In particular, it is envisaged that the electrical connection in the interface area is in communication with a control unit of the treatment device, in particular a central control device of the treatment device, e.g. a foot pedal. It is also conceivable, for example, that the treatment device, in particular the primary device, and simultaneously the modular secondary instrument can be controlled via the control unit. In particular, the operation of the currently connected secondary instrument can be monitored or controlled via the control unit. For communication between the control unit and the secondary instrument, a standardized protocol can be used, such as a CAN bus. It is also conceivable that the communication is wireless. In a simple embodiment, the communication between the control unit and the secondary instrument can be limited to the transmission of the activation signal of the secondary instrument.

It is particularly preferred that a tartar removal device, in particular a piezoelectrically operated tartar removal device, a so-called “scaler”, is integrated into the treatment device as a primary instrument or is provided separately from the secondary instrument.

Preferably, it is provided that the first supply line and/or the second supply line and/or the third supply line comprises a check valve and/or the first and/or the second and/or the third connection is designed as a plug-in mechanism and/or self-closing. In particular, the design of a check valve in the first and second supply lines makes it possible to advantageously prevent backflowing media or operating media from flowing into the treatment device via the interface on the instrument carrier-side and contaminating it. By a self-closing mechanism is preferably meant such a mechanism in which one end of the first port and/or the second port is closed as soon as the secondary instrument is not connected. This, in turn, allows to prevent media or operating fluids from entering the first supply line and/or the second supply line, which are provided for the modular secondary instrument during operation. Alternatively, it is also conceivable that a flap is provided which closes off or covers the instrument carrier-side interface. It is also conceivable that an insert is provided which is inserted into and fills the interface on the instrument carrier side so that the instrument carrier without the modular secondary instrument provides a smooth storage surface for an attending physician to place the instrument.

In particular, a foot pedal is provided for controlling the primary instrument and/or the secondary instrument. It is particularly advantageous if the foot pedal serves to control both the primary instrument and the secondary instrument. In this context, the foot switch may in particular be a wireless foot switch which communicates with the control device and/or the primary instrument and/or the secondary instrument via radio signals for the exchange of information and control signals. In this case, the communication between the secondary instrument and the treatment device can take place via a standardized protocol, e.g. via a CAN bus or Bluetooth.

In a preferred embodiment, the central control device takes over the control of the secondary instrument in that the central control device imitates the function of the foot switch and manages the secondary instrument as a further functional unit. For example, activation and/or control of the secondary instrument can be performed via the foot switch of the treatment device.

Furthermore, it is preferably provided that a fluid, in particular a liquid, which is provided to the modular secondary instrument on the instrument carrier via the first and/or second supply line, is provided by a water treatment system of the treatment device. In particular, the water treatment system of the treatment device is provided primarily for the primary instrument, in particular for the hand instrument designed as a hand-held instrument with a water outlet, which is provided for rinsing the oral cavity. Accordingly, the primary instrument and secondary instrument advantageously share the water treatment system of the treatment unit. This means that the secondary instrument can also be integrated into cleaning and disinfection programs of the treatment device.

Furthermore, it is preferably provided that the instrument carrier comprises a receiving area for the secondary instrument in the form of a recessed course on the outside of the instrument carrier. In particular, it is provided that the outer side is shaped in such a way that insertion or removal of the modular secondary instrument is simplified. This can be realized, for example, by the recessed course enabling insertion or insertion, preferably guided insertion or insertion, for the secondary instrument. Guiding means can also be arranged, such as guide rails or guide pins, which facilitate insertion or removal and ensure a reliable connection. Furthermore, it is preferably provided that the recessed course interacts in a form-fitting and/or force-fitting manner with the secondary instrument in the assembled state of the modular secondary instrument, so that the modular secondary instrument is fixed to the instrument carrier. For example, the recessed course corresponds to at least a part of the housing base of the powder jet instrument. In particular, the recessed course permits insertion of the secondary instrument. It is also conceivable that the recessed section has, for example, an inclined bottom surface, which favors a run-off of operating media, which may escape from the powder jet device during operation.

In particular, it is provided that an interface on the instrument carrier side and an interface on the powder jet device side interact in the assembled state, in particular via the first connection, the second connection, the electrical connection and/or the mechanical fixation mechanism, in the sense of a key-lock mechanism. In other words, the interface on the powder jet device side and the interface on the instrument carrier side are designed to be complementary and/or compatible with one another, so that, for example, a first and/or second coupling component of the interface on the powder jet device side can be plugged into the first connection and/or the second connection of the interface on the instrument carrier side.

Accordingly, the first connection and the second connection are adapted to the first and/or second coupling component of the powder jet device. For example, the first coupling component and the second coupling component of the powder jet device can be inserted into corresponding recesses on the interface on the instrument carrier side, wherein a cross-section of the first coupling component and/or the second coupling component is matched in terms of dimension and geometry or is designed to be dependent on the cross-section of a receiving area of the first and/or second connection in the area of the interface on the instrument carrier side. This makes it possible to prevent the first supply line and/or second supply line from being used for purposes not intended. For example, it is conceivable that the first and/or the second coupling component or the receptacle on the instrument carrier side of the first port and the second port have a first and/or a second filter that are interchangeable. In this way, it is advantageously possible to provide filters in the interface area between the modular secondary instrument and the instrument carrier, which allow the operating media, in particular the water and/or the compressed air, to be treated.

In a further embodiment, it is conceivable that the primary instrument or at least one of the primary instruments is configured such that the primary instrument provides the first port and/or the second port for connection to the first supply line and the second supply line. In other words: If the primary instrument is used, for example, for supplying water to the secondary instrument, it is conceivable that the operating medium is provided to the secondary instrument via a corresponding connection line of the interface on the instrument carrier side. For this purpose, it is necessary, for example, that the primary instrument provides the liquid or fluid at a desired, required pressure that is suitable for the operation of the secondary instrument. The same applies to the compressed air.

In a particularly preferred embodiment of the present disclosure, it is provided that the secondary instrument comprises an output channel for supplying a hand-held device, wherein the output channel is connected to the instrument carrier in the assembled state. In other words, the provided powder-gas mixture of the powder jet device and/or the liquid are again supplied to the instrument carrier via the output channel and are provided from there to a corresponding hand-held device for emission of the powder-gas mixture. This has the advantage that all hand-held devices can be placed centrally at one point in the treatment unit, in particular on a common instrument carrier. Alternatively, it is conceivable that the hand-held device is connected directly to the secondary instrument and the corresponding output channel does not make a detour via the instrument carrier and/or the treatment unit.

Preferably, it is provided that the instrument carrier comprises a pivot arm and/or a displaceable trolley. In particular, it is intended that the primary and secondary instruments are arranged together on one instrument carrier, or the modular secondary instrument is attached to or arranged on its own instrument carrier when mounted, and/or the primary instruments are part of another instrument carrier. In particular, a pivot arm or a trolley allows the instrument carrier to be aligned as desired so that a user, in particular a treating physician, can align the instrument carrier with the secondary instrument in such a way that optimal treatment is possible.

The pivot arm can be laterally displaceable, its height adjustable, and its holding area for the secondary instrument can also be rotatable and tiltable. The pivot arm is preferably arranged under the treatment chair.

Preferably, it is provided that the secondary instrument is usable independently of the treatment device. In other words, the secondary instrument is functional independently of the treatment device, provided that the corresponding operating resources are made available to the secondary instrument. Accordingly, the treatment device, in particular the instrument carrier, serves in the present case only as a supply point that provides the necessary operating means, i.e. liquid and gas, to the modular secondary instrument. In particular, the exchangeable or reversible arrangement of the secondary instrument on the instrument carrier makes it advantageously possible to exchange the secondary instrument easily and/or to separate it from the instrument carrier at short notice for maintenance work or cleaning purposes.

A further object of the present disclosure is a treatment device with an instrument carrier according to the disclosure, wherein a powder jet device is arranged at the interface as a secondary instrument. All the features and advantages described for the instrument carrier can be transferred analogously to the treatment device and vice versa. Preferably, the treatment device is a treatment chair.

### BRIEF DESCRIPTION OF THE DRAWINGS

Further advantages and features result from the following description of preferred embodiments of the subject-matter according to the disclosure with reference to the attached figures. Individual features of the individual embodiment can thereby be combined with each other within the scope of the disclosure.

It is shown in:

FIG. 1: a treatment device according to a first preferred embodiment of the present disclosure,

FIG. 2: a treatment device according to a second preferred embodiment of the present disclosure,

FIG. 3: an interface on the powder jet device side according to a first preferred embodiment of the present disclosure; and

FIG. 4: an interface on the powder jet device side according to a second preferred embodiment of the present disclosure.

### DETAILED DESCRIPTION

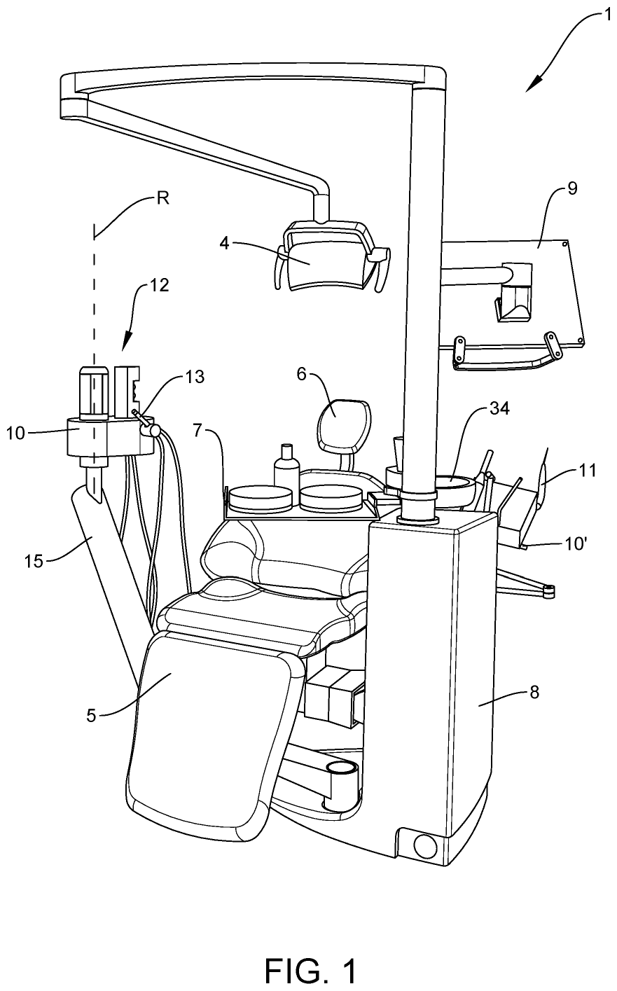

FIG. 1 shows a treatment device 1 according to a first preferred embodiment of the present disclosure. Such treatment devices 1 are in particular dental treatment devices which are provided for dental treatment and/or prophylaxis of teeth of a patient. In this regard, such a treatment device 1 comprises, for example, a chair 5 with a headrest 6, on which the patient is seated for the treatment. The chair 5 is supported by a central body 8, with which the chair 5 communicates in particular in such a way that individual backrest parts of the chair 5 or the headrest 6 can be pivoted relative to one another in order to ensure optimum alignment of the patient for treatment.

The treatment device 1 additionally comprises, for example, a light source 4 which is attached or articulated to the central body 8 in such a way that it can be pivoted and aligned, in particular aligned in three dimensions, and a screen 9 which can provide the treating physician with information. A further component of the treatment device 1 may be a sink 34.

The embodiment of the treatment device 1 shown in FIG. 1 further provides a sideboard element 7, which is essentially formed from a plate-shaped and pivotable body, on which the doctor to be treating can deposit or temporarily store instruments and/or consumables for his treatment or for the planned treatment. In the present example, the sideboard element 7 is pivotably arranged on the central body 8 of the treatment device 1. Furthermore, the treatment device 1 comprises an instrument carrier 10 and a further instrument carrier 10′. In this case, the further instrument carrier 10′ is connected to the central body 8 via at least one joint and can be transferred to a desired position by means of the at least one joint, for example by a pivoting movement. In particular, in the example shown in FIG. 1, it is provided that at least one primary instrument 11 is provided on the further instrument carrier 10′. As primary instrument 11, for example, there are imaginable
a device for removing tartar, a so-called “scaler”,
a hand-held device for emitting compressed air and/or water for cleaning the mouth region and/or
a hand-held device for aspirating saliva fluid and/or other fluid and/or
a hand-held device with a rotating head part, on which optionally a brush and/or a drill head can be mounted interchangeably, and/or
a universal supply coupling (e.g. KaVo Multiflex or SIRONA Click & Go coupling) for the operation of various instruments.

In particular, it is provided that the treatment device 1 comprises an instrument carrier 10, which is connected to the central body 8 via a pivot arm 15 and provides an interface for receiving a modular secondary instrument 12. In particular, it is provided in FIG. 1 that, here, the instrument carrier 10 is formed separately from the further instrument carrier 10′ and/or preferably has a powder jet device as the modular secondary instrument 12. In particular, it is provided that the instrument carrier 10 can be swiveled via the pivot arm 15, and/or can be adjusted in height by means of a joint, and/or can additionally be rotated about an axis of rotation R, in particular a vertically extending axis of rotation R, so that the instrument carrier 10 with the modular secondary instrument 12 can be displaced in all three spatial directions and, if necessary, can additionally be rotated about the axis of rotation R, in order to be aligned in an optimum position for treatment at any desired position next to the chair 5.

In particular, it is provided that the modular secondary instrument 12 has a hand-held device 13 with which both a powder-gas mixture and a fluid, in particular a liquid, can be emitted via a jet nozzle. The emitted or ejected powder-gas mixture, in particular surrounded by a fluid stream, is then used in particular for tooth cleaning, in particular prophylactic tooth cleaning, in which, for example, biofilms, tartar and/or the like are removed.

For this purpose, the modular secondary instrument 12 is designed as a powder jet device, which has, for example, a chamber for mixing the powder-gas mixture. In order to provide an interface on the instrument carrier side for the secondary instrument 12, it is provided that the instrument carrier 10 comprises at least a first connection and/or a second connection, which ensure a supply of the secondary instrument 12 with means of demand. For example, the first connection serves to connect the secondary instrument 12 to a first supply line on the instrument carrier side and/or the second connection serves to connect the secondary instrument 12 to a second supply line on the instrument carrier side. In this case, the first and the second supply lines preferably run within the instrument carrier 10, and/or the pivot arm 15 and/or the central body 8. For example, the first connection line provides compressed air, in particular for a pressure between 2 and 8 bar, and/or the second supply line provides water, in particular water with a pressure between 0 and 5 bar.

Via the first connection and the second connection, the operating means are provided to the secondary instrument 12 by the instrument carrier 10. It is further provided that the treatment device 1, in particular the instrument carrier 10, in addition to the first connection and the second connection, provides a further electrical connection (not shown) for supply and/or information exchange with the secondary instrument 12. For this purpose, for example, the corresponding first supply line and/or the second supply line and/or an electrical line run inside the pivot arm 15, which is connected to the central body 8, up to the instrument carrier 10 and are provided there on the outside thereof to the secondary instrument 12 via the first connection, the second connection and/or the electrical connection. It is further conceivable that the primary instrument 11 is integrally formed with the further instrument carrier 11.

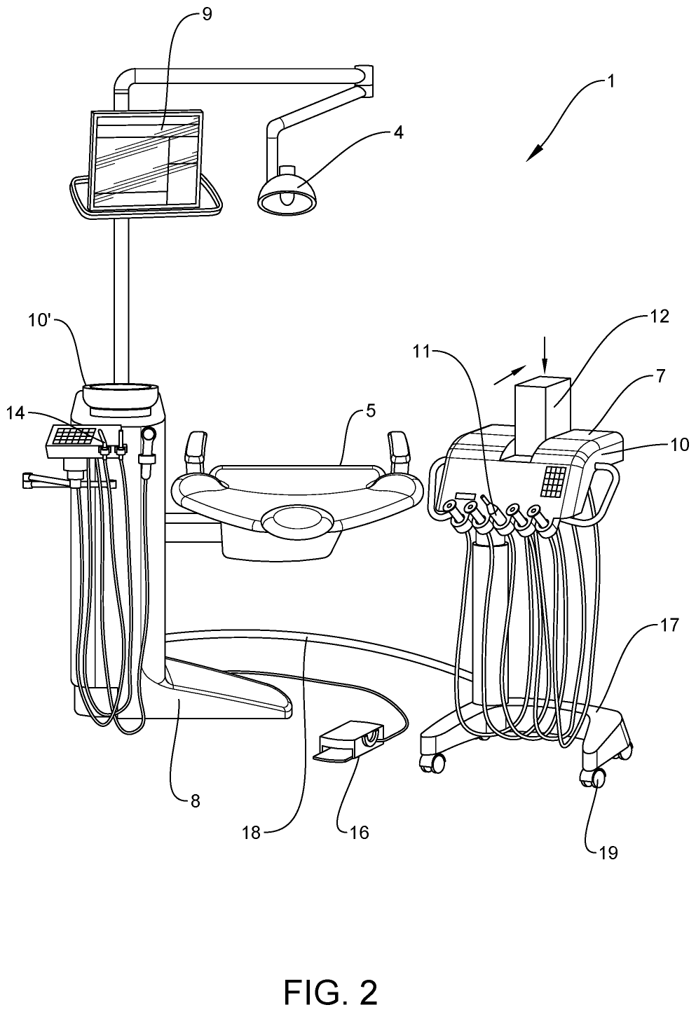

FIG. 2 shows a treatment device 1 according to a second embodiment of the present disclosure. Here, the embodiment of FIG. 2 differs from that of FIG. 1 essentially only in that the instrument carrier 10 for the modular secondary instrument 12 is designed as a trolley 17. Such a trolley 17 comprises rollers 19 on its underside which allow it to be moved to any desired location. Via a central supply line 18, the trolley 17 is in direct connection with the central body 8, on which further primary instruments 11 are provided, for example.

Furthermore, it is preferably provided that the treatment device 1 comprises a foot pedal 16, wherein the foot pedal 16 is provided in particular for communication with the primary instrument 11 and/or the secondary instrument 12. In this context, it is conceivable, for example, that the foot pedal 16 is in wireless communication with the primary instrument 11 and/or the secondary instrument 12. Furthermore, it is provided that a control device is integrated into the instrument carrier 10 and/or the treatment device 1, with which both the primary instrument 11 and the secondary instrument 12 can be controlled. For example, a switch can be used to cause a change for control between the primary instrument 11 and the secondary instrument 12. Furthermore, it is conceivable that the instrument carrier 10 has a display, in particular a touch display, which provides the treating physician with information and/or allows the primary instrument 11 and/or the secondary instrument 12 to be controlled or communication with a central control unit of the treatment device 1.

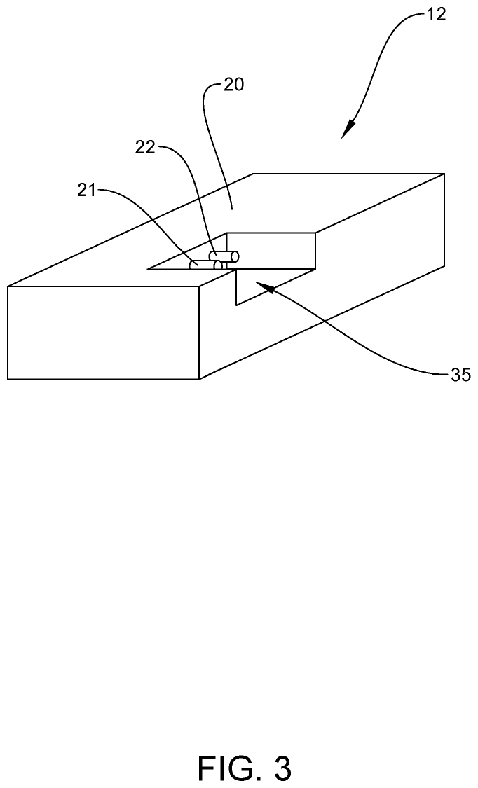

FIG. 3 schematically shows an interface 35 on the powder jet device side according to a preferred embodiment of the present disclosure. In particular, FIG. 3 shows an underside of the housing 20 of the modular secondary instrument 12.

In this case, in particular the interface 35 on the powder jet device side is designed as a recessed course in which a first coupling element 21 and a second coupling element 22 are provided, in particular formed on a rear wall of the recessed course in the housing 20 of the modular secondary instrument 12. In this case, in particular the recessed course can be used for mechanical fixation and/or coupling to the instrument carrier 10, for example to a correspondingly designed projection of the instrument carrier 10. In this context, it is preferably provided that a complementarily configured interface on the instrument carrier side is provided which, in particular in the assembled state of the secondary instrument 12, interacts in a form-fitting and/or force-fitting manner with the interface 35 on the powder jet device side. Furthermore, it is preferably provided that the first coupling element 21 and/or the second coupling element 22 is designed as a plug-in element, wherein in the assembled state the first coupling element 21 engages or is plugged into the first connection and/or the second coupling element 22 engages or is plugged into the second connection.

Therein, for engaging the first connection and the second connection, these are preferably formed complementary to the first coupling element 21 and the second coupling element 22 as corresponding recesses in the interface on the instrument carrier side. In particular, this makes it possible to implement a lock-and-key principle that permits simple connection of the modular secondary instrument 12 to the instrument carrier 10 and ensures that the correct secondary instrument 12 is connected to the instrument carrier 10.

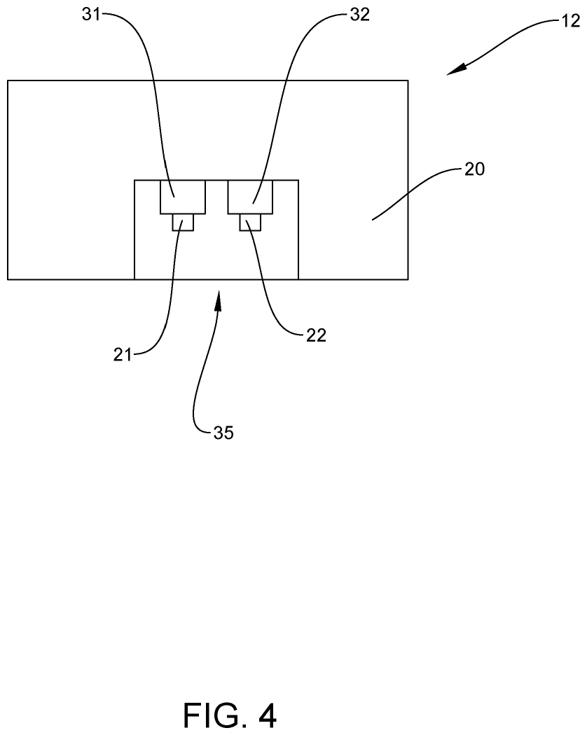

FIG. 4 shows a further interface 35 on the powder jet device side according to a second preferred embodiment of the present disclosure. Essentially, the interface area on the powder jet device side of FIG. 4 corresponds to that of FIG. 3 and differs essentially only in that in the interface 35 on the powder jet device side of FIG. 4 it is additionally provided that the first coupling component 21 is encased, in particular partially encased, by a sleeve-like first filter 31 and the second coupling component 22 is encased by a sleeve-like second filter 32. Therein, it is provided in particular that, in the assembled state, the first coupling component 21 and/or the second coupling component 22 reach correspondingly through the first filter 31 and/or the second filter 32. In this case, the first coupling component 21 and/or the second coupling component 22 are designed in such a way that a supply medium or operating medium, such as water and/or compressed air, enters at the end face of the first coupling component 21 and/or the second coupling component 22, then performs a lateral offset in order to be guided through the first filter 31 and/or the second filter 32. After flowing through the first filter 31 and/or the second filter 32, the operating fluid is directed back into the first coupling component 21 and/or the second coupling component 22. In particular, the first filter 31 and the second filter 32 are designed to be replaceable, so that the first filter 31 and/or the second filter 32 can be replaced easily and regularly in the region of the first connection and the second connection or in the region of the first coupling component 21 and/or the second coupling component 22, so that permanently filtered operating media, in particular compressed air and/or liquid, can be made available to the powder jet device, i.e. the secondary instrument 12.

1. An instrument carrier of a treatment device, in particular a dental treatment device, comprising:
a primary instrument provided on the treatment device and wherein at least a part of the at least one primary instrument is an integral component of the treatment device; and
an interface on an instrument carrier side for reversibly connecting a modular secondary instrument, wherein the secondary instrument is a powder jet device, wherein by means of the interface the modular secondary instrument is arranged on the outside of the instrument carrier, wherein by means of the interface the modular secondary instrument is arranged on the outside of the instrument carrier.

2. The instrument carrier according to claim 1, wherein the interface on the instrument carrier side, for connecting the secondary instrument, comprises
a mechanical fixation mechanism and/or
at least one first connection for reversibly connecting, a first supply line to a first coupling element of the secondary instrument and/or a second connection for reversibly connecting, a second supply line to a second coupling element of the secondary instrument and/or
an electrical connection for the power supply and/or for information exchange.

3. The instrument carrier according to claim 2, wherein
the first supply line and/or the second supply line comprises a check valve and/or
the fixation mechanism for connection comprises a plug-in mechanism and/or is self-closing.

4. (canceled)

5. The instrument carrier according to claim 1, wherein a connecting line is provided which connects the secondary instrument to the instrument carrier and via which a powder-gas mixture is conveyed or conducted from the secondary instrument to the instrument carrier, which in turn supplies a hand-held device associated with the secondary instrument with the powder-gas mixture.

6. The instrument carrier according to claim 1, wherein a valve is provided for adjusting an amount of a powder-gas mixture to be ejected, the valve being arranged outside the instrument carrier.

7. The instrument carrier according to claim 6, wherein the valve is part of the secondary instrument.

8. The instrument carrier according to claim 1, wherein the instrument carrier comprises a receiving area for the secondary instrument in the form of a recessed course on the outside of the instrument carrier.

9. The instrument carrier according to claim 1, wherein a foot pedal is provided for controlling the primary instrument and/or the secondary instrument.

10. The instrument carrier according to claim 1, wherein an interface on the instrument carrier side and an interface on the powder jet device side interact in the assembled state, via the first connection, the second connection, the electrical connection and/or the mechanical fixation mechanism, in the sense of a key-lock mechanism.

11. The instrument carrier according to claim 1, wherein the secondary instrument comprises an output channel for supplying a hand-held device, wherein the output channel is connected to the instrument carrier in the assembled state.

12. The instrument carrier according to claim 1, wherein the instrument carrier comprises a pivot arm and/or a displaceable trolley.

13. The instrument carrier according to claim 1, wherein the secondary instrument is usable independently of the treatment device.

14. A treatment device with an instrument carrier according to claim 1, wherein a powder jet device is arranged at the interface as a secondary instrument.

15. The treatment device according to claim 14, wherein the treatment device is a treatment chair.
